(19) United States
(12) Patent Application Publication
(10) Pub. No.: US 2019/0340636 A1
(43) Pub. Date: Nov. 7, 2019

(54) METHOD AND SYSTEM FOR FACILITATING EARNING OF REWARD POINTS

(71) Applicant: MASTERCARD INTERNATIONAL INCORPORATED, Purchase, NY (US)

(72) Inventors: Rahul AGRAWAL, Pune (IN); Sudhir GUPTA, Pune (IN); Harsh PIPARSANIYA, Pune (IN)

(21) Appl. No.: 16/404,877

(22) Filed: May 7, 2019

(30) Foreign Application Priority Data
May 7, 2018 (SG) 10201803842X

(51) Int. Cl. G06Q 30/02

(52) U.S. Cl. CPC G06Q 30/0233; G06Q 30/0238; G06Q 30/0236

(57) ABSTRACT

Methods and server systems for facilitating earning of reward points on payment card transactions by users are disclosed. An estimate of reward points earned by a user in a preset interval is determined based on payment card transactions previously executed by the user. At least one option associated with a respective reward point target and a predetermined award for achieving the reward point target is generated. The reward point target is greater than the estimate of reward points. Subsequent to the user selection of an option, reward points earned in each future preset interval for a predefined time duration are tracked. In response to achieving the reward point target associated with the selected option in each future preset interval for the predefined time duration, the predetermined award associated with the selected option is credited to a payment account associated with the user.

### CROSS-REFERENCE TO RELATED APPLICATIONS

This application claims priority to Singapore Patent Application No. 10201803842X filed on May 7, 2018, which is hereby incorporated by reference in its entirety.

### TECHNICAL FIELD

The present disclosure relates to payment card related financial transactions and, more particularly to, a method and system for facilitating earning of reward points on payment card transactions by users.

### BACKGROUND

Nowadays, most users use several banking cards, such as credit cards, debit cards, prepaid cards, etc. for performing financial transactions. The banking cards, also referred to herein as payment cards, may be used for financial transactions, such as for making payment at a point-of-sale (POS) terminal, for making an online purchase transaction, or even for withdrawing currency from an Automated Teller Machine (ATM).

Typically, to encourage payment card transactions, issuers of payment cards grant reward points to the users for each payment card transaction. More specifically, each payment card transaction by the user earns the user a certain number of reward points depending upon the type of payment card, an amount of the transaction, and in some cases, on the category of goods or services purchased at merchant outlets. Generally, an issuer of a payment card may set milestones on accrual of reward points and a user after reaching a milestone may redeem the reward points towards eligible awards, such as purchase of certain goods or services. In most cases, it takes a long time for the user to accrue sufficient number of reward points to reach a milestone. As a result, there is no motivation for the users to accumulate reward points and as such, the reward points are not used by the users.

Accordingly, there is a need to motivate users to engage in payment card transactions and actively work towards earning of reward points. It would also be advantageous to enable the users to reach reward point milestones quicker to enable the users to redeem the reward points towards purchase of desired goods and services.

### SUMMARY

Various embodiments of the present disclosure provide systems, methods, electronic devices and computer program products to facilitate earning of reward points on payment card transactions by users.

In an embodiment, a method for facilitating earning of reward points on payment card transactions by a user is disclosed. The method includes determining, by a server system associated with a payment network, an estimate of reward points earned by a user in a preset interval. The estimate is determined based on payment card transactions previously executed by the user. The method includes generating at least one option by the server system based at least in part on the estimate of reward points. Each option from among the at least one option is associated with a respective reward point target and a predetermined award for achieving the respective reward point target. The respective reward point target is greater than the estimate of reward points and the respective reward point target to be achieved by the user in each future preset interval for a predefined time duration. The method includes providing the at least one option, by the server system, to the user for user selection. Subsequent to the user selection of an option from among the at least one option, the method includes tracking by the server system, reward points earned in the each future preset interval for the predefined time duration. In response to achieving the reward point target associated with the selected option in the each future preset interval for the predefined time duration, the method includes facilitating, by the server system, crediting of the predetermined award associated with the selected option to a payment account associated with the user.

In another embodiment, a server system configured to facilitate earning of reward points on payment card transactions by users is disclosed. The server system includes a communication interface for receiving a selection of an offer by a user. The offer requests the user to provide a commitment to achieve a target number of reward points in each future preset interval for a predefined time duration in return of an award. The server system further includes a memory comprising stored instructions and a processor communicably coupled to the communication interface. The processor is configured to execute the stored instructions to cause the server system to determine an estimate of reward points earned by the user in a preset interval. The estimate is determined based on payment card transactions previously executed by the user. The server system is caused to generate at least one option based at least in part on the estimate of reward points. Each option from among the at least one option is associated with a respective reward point target and a predetermined award for achieving the respective reward point target. The respective reward point target is greater than the estimate of reward points and the respective reward point target is to be achieved by the user in the each future preset interval for the predefined time duration. The server system is caused to provide the at least one option to the user for user selection. Subsequent to the user selection of an option from among the at least one option, the server system is caused to track reward points earned in the each future preset interval for the predefined time duration. In response to achieving the reward point target associated with the selected option in the each future preset interval for the predefined time duration, the server system is caused to facilitate crediting of the predetermined award associated with the selected option to a payment account associated with the user.

In an embodiment, another method for facilitating earning of reward points on payment card transactions by a user is disclosed. The method includes providing, by a payment server associated with a payment network, a recurring rewards deposit (RRD) offer to a user. The RRD offer requests the user to provide a commitment to achieve a target number of reward points in each future monthly billing cycle period for a predefined time duration in return of an award. Subsequent to a selection of the RRD offer by the user, the method includes determining by the payment server, an average number of reward points earned in a monthly billing cycle period by the user. The average number of reward points is determined based on payment card transactions previously executed by the user. The method includes generating at least one option by the payment server based at least in part on the average number of reward points. Each option from among the at least one option is associated with a respective reward point target and a predetermined number of bonus reward points for achieving the respective reward point target. The respective reward point target is to be achieved by the user in the each future monthly billing cycle period for the predefined time duration. The method includes providing the at least one option, by the payment server system, to the user for user selection. Subsequent to the user selection of an option from among the at least one option, the method includes tracking by the payment server, reward points earned in the each future monthly billing cycle period for the predefined time duration. In response to achieving the reward point target associated with the selected option in the each future monthly billing cycle period for the predefined time duration, the method includes facilitating, by the payment server, crediting of the predetermined number of bonus reward points associated with the selected option to a payment account associated with the user.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 represents a sequence flow diagram for illustrating a server system facilitating user registration to a recurring rewards deposit (RRD) offer for earning of reward points on payment card transactions by a user, in accordance with an example embodiment of the present disclosure;

FIG. 3 shows a representation of a UI associated with a user payment account for illustrating an example recurring rewards deposit (RRD) offer displayed to the user, in accordance with an example embodiment of the present disclosure;

FIG. 4 shows a simplified representation of a listing of payment card transactions previously executed by the user for illustrating a determination of an estimate of reward points earned in a preset interval, in accordance with an example embodiment of the present disclosure;

FIG. 5 shows a simplified representation of a UI illustrating two options related to reward point targets presented to a user, in accordance with an example embodiment of the present disclosure;

FIG. 6 shows an example representation of a UI provisioned to the user for verification of user's payment card information, in accordance with an example embodiment of the present disclosure;

FIG. 7 represent a sequence flow diagram for illustrating a server system facilitating crediting of the predetermined award to the user's payment account subsequent to the user achieving the reward point target, in accordance with an example embodiment of the present disclosure;

FIG. 8 shows a simplified representation of a UI displaying a status of reward points in the user's payment account, in accordance with an example embodiment of the present disclosure;

FIG. 9 illustrates a flow diagram of a method for facilitating earning of reward points on payment card transaction by users, in accordance with an example embodiment of the present disclosure;

FIG. 10 is a simplified block diagram of a server system used for facilitating earning of reward points on payment card transactions by users, in accordance with an example embodiment of the present disclosure;

FIG. 11 is a simplified block diagram of a POS terminal used for a payment card transaction, in accordance with an example embodiment of the present disclosure;

FIG. 12 is a simplified block diagram of an issuer server for facilitating earning of reward points on payment card transactions by users, in accordance with one embodiment of the present disclosure;

FIG. 13 is a simplified block diagram of an acquirer server used for facilitating earning of reward points on payment card transactions by users, in accordance with one embodiment of the present disclosure;

FIG. 14 is a simplified block diagram of a payment server used for facilitating earning of reward points on payment card transactions by users, in accordance with one embodiment of the present disclosure; and

FIG. 15 shows simplified block diagram of a user device for example a mobile phone or a desktop computer capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but is not limited to a savings account, a credit account, a checking account and a virtual payment account. The payment account may be associated with an entity such as an individual person, a family, a commercial entity, a company, a corporation, a governmental entity, a non-profit organization, and the like. In some scenarios, a payment account may be a virtual or temporary payment account that can be mapped or linked to a primary payment account, such as those accounts managed by PayPal®, and the like.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

### Overview

Current schemes for awarding reward points to users on payment card transactions do not provide any motivation to the users to actively work towards accumulating reward points and achieving reward point milestones. With no motivation to engage in additional payment card transactions, it takes the user a long time to accumulate enough reward points to meet the reward point milestones. As a result, the reward points in most cases are not utilized and the purpose of awarding reward points is not achieved.

Various example embodiments of the present disclosure provide methods, and systems for overcoming the above drawbacks and providing additional advantages. More specifically, various embodiments as disclosed herein facilitate earning of reward points by users of payment cards. The user is motivated to actively engage in payment card transactions to meet the reward points milestones. The user may then redeem the reward points towards eligible purchases. The issuer of the payment card and other entities on the payment network stand benefited by additional payment card transactions by the user, whereas the utilization of reward points towards purchase of goods and services benefits the user and greatly enhances the user experience of using the respective payment card.

In one embodiment, the user may login to a payment account associated with the user. The payment account may be maintained by a server system associated with a payment network, such as a Mastercard® payment system interchange network. After login, the user may be provided with an UI including an offer, also referred to herein as the recurring rewards deposit (RRD) offer, for user selection.

The RRD offer requests the user to provide a commitment to achieve a target number of reward points in return of an award. The target number of reward points is to be achieved in each future preset interval for a predefined time duration. The term ‘each future preset interval’ as used hereinafter may imply a fixed time interval, such as a monthly billing cycle period for instance. A non-limiting example of a predefined time duration may be a duration of six months. Accordingly, in an illustrative example, by selecting the RRD offer, the user may commit to achieving a fixed number (i.e. a target number) of reward points in every monthly billing cycle period for six months and, in return, the user will receive an award, such as for example a predetermined number of bonus reward points.

In some embodiments, after the selection of the RRD offer, the server system is configured to use information related to the user's payment card to retrieve payment card transactions previously executed by the user. The history of payment card transactions is used to determine an estimate of reward points earned in a preset interval by a user. The estimate of the reward points earned in the preset interval is indicative of how many reward points the user usually accumulates in a given time period. In an illustrative example, an average of a number of reward points earned per monthly billing cycle period in the past year or past two years may be computed. The average number of reward points that the user earns in each monthly billing cycle period may be considered as the estimate of the reward points earned in the preset interval by the user.

In order to encourage the user to perform more payment card transactions than usual, in at least one example embodiment, the server system generates at least one option based at least in part on the estimate of reward points. Each option is associated with a respective reward point target and a predetermined award for achieving the respective reward point target. The reward point target associated with each generated option is purposefully chosen to be greater than the estimate of reward points to encourage additional payment card transactions. Furthermore, the reward point target is to be achieved by the user in each future preset interval for a predefined time duration. For example, the server system determines one or more targets for reward points that the user can aim to achieve in each monthly billing cycle period for a fixed duration, such a nine-month period.

To determine the target number of reward points, in one embodiment, the server system uses one or more machine learning based algorithms. The term ‘machine learning algorithms’ as used hereinafter includes both machine learning (ML) and artificial intelligence (AI) models. The one or more ML based algorithms are configured to enable identification of a pattern of payment card related spending by the user. Further, such algorithms enable prediction of the at least one reward point target capable of being earned by the user based on the identified pattern of payment card related spending. For example, if the user currently earns 200 reward points on an average per monthly billing cycle period, then using the ML based algorithms, the server system may determine that the user can earn 300 or 350 reward points in each monthly billing cycle period. It is noted that the reward point target associated with each generated option is associated with a respective predetermined award. In one illustrative example, the predetermined award corresponds to a predetermined number of bonus reward points. For example, if the user achieves a reward point target of 300 reward points in each monthly billing cycle period for six months, then the user may be awarded 100 bonus reward points, or if the user achieves a reward point target of 350 reward points in each monthly billing cycle period for six months, then the user may be awarded 200 bonus reward points.

In one embodiment, the server system is further configured to provide the one or more options with corresponding reward point targets to the user for user selection. In an illustrative example, the server system may have identified two possible options for reward point targets that the user can achieve. For example, if a user can achieve 300 or 350 reward points, then the server system may provide both of these reward point targets to the user as options for user selection. Each reward point target is associated with an accompanying award. For example, earning 300 reward points every month for six months may be associated with an award of 200 bonus reward points, whereas earning 350 reward points every month for six months may be associated with an award of 230 bonus reward points. The user may provide a selection of one option from among the reward point target related options presented to the user.

In response to the user selection of an option, in one embodiment, the user may be requested to verify information related to the user's payment card and thereby register for the RRD offer. In some embodiments, the user may be requested to provide information such as a payment card number, payment card expiry details, a Card Verification Value associated with the payment card, a phone number and the like. In some embodiments, the provisioning of the information related to the payment card may be precluded and the server system may fetch the information from an associated database after the selection of the RRD offer and automatically register the user to the RRD offer.

Subsequent to the user registration, the server system tracks reward points earned in each future preset interval by the user for the predefined time duration. Further, the server system is configured to credit the respective predetermined award, such as for example the predetermined number of bonus reward points, if the user has achieved the reward point target associated with the selected option in each future preset interval for the predefined time duration.

In one embodiment, the server system causes display a total number of reward points and the predetermined number of bonus reward points earned by the user after the completion of the predefined time duration. For example, the server system may cause display of an UI showing the number of bonus reward points (for example, 200 reward points) along with the total number of reward points (for example, 500 reward points) currently in balance in the payment account of the user. Furthermore, the server system may facilitate redemption of at least a portion of the total number of reward points after the crediting of the bonus reward points in the user's payment account.

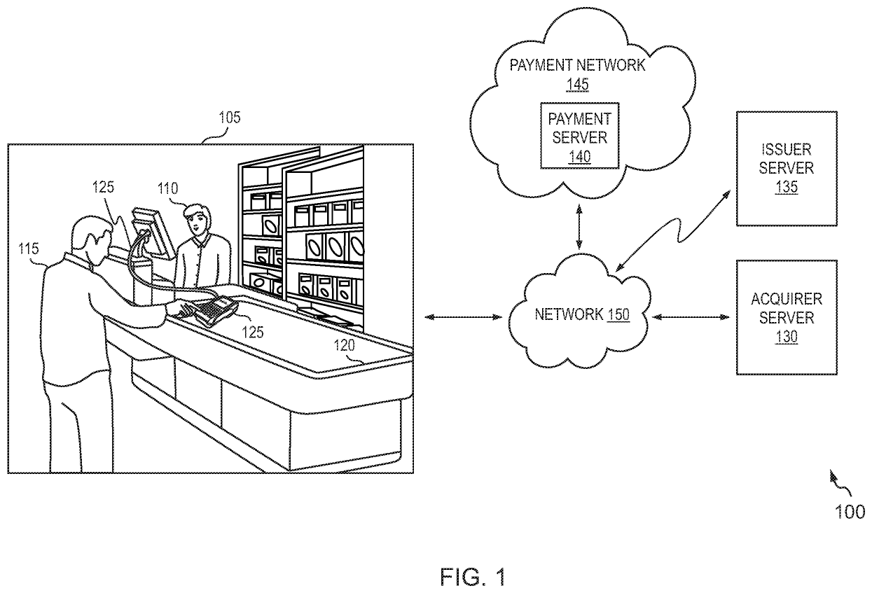

FIG. 1 illustrates an example representation of an environment 100, in which at least some example embodiments of the present disclosure can be implemented. In the illustrated embodiment, a facility 105 is shown. Examples of the facility 105 may include any retail shop, supermarket or establishment, a government and/or private agency, a ticket counter, or any such place or establishment where users perform financial transactions in exchange of any goods and/or services or any transaction that requires financial transaction between the user and the facility 105.

As can be seen from the environment 100, a customer 115 is standing near a payment desk 120 to make a financial transaction to a merchant 110 for a product purchased by the customer 115 from the facility 105. The facility 105 also includes a merchant interface 125. Examples of the merchant interface 125 include a point of sale device or a point of sale terminal 125 (hereinafter interchangeably referred to as a ‘POS terminal 125’) placed on the payment desk 120 using which the payment transaction can be initiated. In various embodiments, the merchant interface 125 can be a merchant telephone, merchant computer system, and the like.

Alternatively, or additionally, the merchant interface 125 can also be an online merchant interface such as a merchant Website, a mobile or desktop application or a third-party Website or application using which the customer 115 may purchase goods or service from a remote location or with in-store presence.

As shown in the environment 100, the customer 115 is entering a personal identification number (PIN) using the POS terminal 125. Alternatively, in the embodiment of the merchant interface being the online merchant interface, the customer 115 may enter payment card details using an electronic device, such as for example his personal computer or a mobile phone or any other electronic device while purchasing a product online from the merchant Website. Some non-exhaustive examples of payment card details entered using the electronic device include payment card number, date of expiry, Card Verification Value (CVV) details, and the like.

In a non-limiting example, authorization of the customer's bank account with sufficient funds for making a transaction of ‘X’ amount to complete the payment transaction is performed by a combination of an acquirer server 130, an issuer server 135 and a payment server 140. In one embodiment, the payment server 140 is associated with a payment network 145. The payment network 145 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 135 is associated with a financial institution normally called as an “issuer bank” or “issuing bank” or simply “issuer”, in which the customer 115 may have an account, which issues a payment card, such as a credit card or a debit card. The customer 115, being the cardholder, can use the payment card details associated with the payment card to tender payment for a purchase from the merchant 110.

To accept payment, the merchant 110 must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor will communicate with the computers of the issuer/the issuer server 135 to determine whether the customer's account is in good standing and whether the purchase is covered by the customer's available account balance. Based on these determinations, authorization of the payment transaction is declined or accepted. When the authorization is accepted, the available balance of the customer's account is decreased. Normally, a charge is not posted immediately to the customer's account because bankcard associations, such as Mastercard International Incorporated®, have promulgated rules that do not allow a merchant to charge, or “capture,” a transaction until goods are shipped or services are delivered. When the merchant 110 ships or delivers the goods or services, the merchant 110 captures the transaction by, for example, appropriate data entry procedures on the POS terminal 125. If the customer 115 cancels a transaction before it is captured, a “void” is generated. If the customer 115 returns goods after the transaction has been captured, a “credit” is generated.

After a transaction is captured, the transaction is settled between the merchant 110, the acquirer and the issuer. Settlement refers to the transfer of financial data or funds between the merchant's account, the acquirer, and the issuer, related to the transaction. Usually, transactions are captured and accumulated into a “batch”, which is settled as a group.

A customer device (e.g., a mobile phone or desktop computer of the customer 115), the merchant device (e.g., the POS terminal 125) associated with the merchant interface, the issuer server 135, the acquirer server 130 and the payment server 140 communicate with one another using a network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

Various embodiments of the present disclosure provide mechanisms that enables users, such as the customer 115, to engage in payment card transactions, such as the payment card transaction explained above, and to actively work towards accumulating reward points. It is noted that the term ‘payment card transactions’ as used herein include transactions where payment card was presented to the merchant (for example, in-store purchase as shown in FIG. 1) and transactions where the payment card was not presented to the merchant (also known as card not present transactions, such as for example, online purchase using the payment card details).

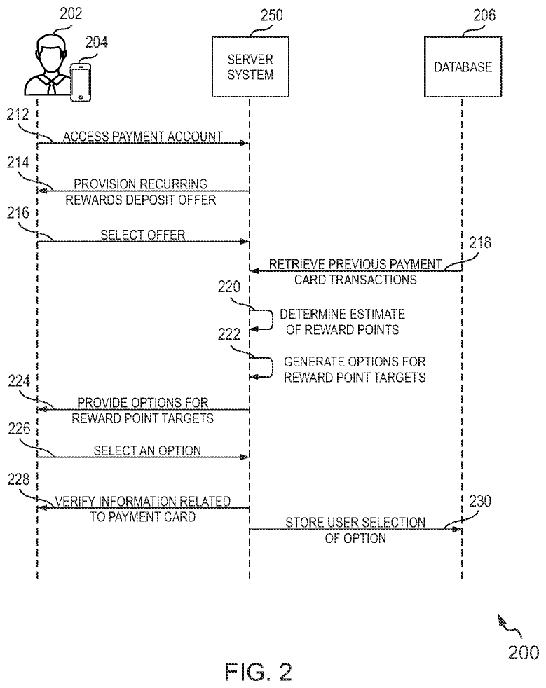

In one embodiment, a user, such as the customer 115, is presented with an offer, also referred to herein as recurring rewards deposit (RRD) offer by a server system associated with the payment network 145. In an illustrative example, the payment server 140 provisions the RRD offer to the user upon access of a payment account associated with the user. The RRD offer requests the user to provide a commitment to achieve a target number of reward points in return of an award. The target number of reward points is to be achieved in each future preset interval for a predefined time duration. The user is then provided with options of reward point targets to choose from by the payment server 140. The user may provide a selection of an option or, more specifically, a selection of a reward point target to be achieved in each future preset interval for a predefined time duration. To meet the reward point target, the user may have to engage in additional payment card transactions than the usual number of payment card transactions the user performs. The reward points earned in each preset interval within the predefined time duration are tracked by the payment server 140. If the user achieves the reward point target in each future preset interval for the predefined time duration, the payment server 140 facilitates crediting of a predetermined award, such as for example, a predetermined number of bonus reward points to the user's payment account. Enabling the user to earn bonus reward points allows the user to reach reward points milestones faster. On accrual of sufficient reward points, the user may redeem the reward points towards eligible purchases. A sequence flow illustrating facilitating user registration to a recurring rewards deposit (RRD) offer is explained with reference to FIG. 2.

FIG. 2 represents a sequence flow diagram 200 for illustrating a server system 250 facilitating user registration to a recurring rewards deposit (RRD) offer for earning of reward points on payment card transactions by a user 202, in accordance with an example embodiment of the present disclosure. The terms ‘server system’, or ‘server’ or ‘system’ are used interchangeably hereinafter. In at least one example embodiment, the term ‘server system 250’ as used herein corresponds to the payment server 140 (shown in FIG. 1). In some embodiments, the server system 250 may correspond to the issuer server 135 or the acquirer server 130 explained with reference to FIG. 1. In some example scenarios, the issuer server 135, the acquirer server 130 and the payment server 140 can be a single entity, or any two of these servers may be a single entity, configuring the server system 250.

At 212, the user 202 using an electronic device 204 accesses an online payment account associated with a user's payment card.

Upon access of the online payment account, at 214, the server system 250 provisions a UI including an offer, also referred to herein as a recurring rewards deposit (RRD) offer. More specifically, the UI is displayed on the user's electronic device 204 for enabling the user selection of the RRD offer. The RRD offer requests the user 202 to provide a commitment to achieve a target number of reward points in return of an award. The target number of reward points is to be achieved in each future preset interval for a predefined time duration.

At 216, the user 202 provides a selection of the RRD offer. The selection of the RRD offer is indicative of the user's commitment to earn the target number of reward points in each future preset interval for the predefined time duration. For example, by selecting the RRD offer, the user 202 may commit to achieving a fixed number (i.e. a target number) of reward points for every monthly billing cycle for six months and, in return, the user 202 will receive an award, such as for example a predetermined number of bonus reward points.

At 218, the server system 250 retrieves payment card transactions previously executed by the user 202 from a database 206 based on the payment card information associated with the user's payment card.

At 220, the server system 250 uses the history of payment card transactions to determine an estimate of reward points earned in a preset interval by the user 202. The estimate of the reward points earned in the preset interval is indicative of how many reward points the user 202 usually accumulates in a given time period. In an illustrative example, an average of a number of reward points earned per monthly billing cycle period in the past year or past two years may be computed. The average number of reward points that the user 202 earns in each monthly billing cycle period may be considered as the estimate of the reward points earned in the preset interval by the user 202.

In order to encourage the user 202 to perform more payment card transactions than usual, at 222, the server system 250 generates at least one option, where each option is associated with a respective reward point target and a predetermined award for achieving the respective reward point target. The one or more options are generated based at least in part on the estimate of reward points typically earned by the user 202 in a preset interval. More specifically, the reward point target associated with each generated option is chosen to be greater than the estimate of reward points to encourage additional payment card transactions.

Furthermore, the reward point target is to be achieved by the user 202 in each future preset interval for a predefined time duration. For example, the server system 250 determines one or more targets for reward points that the user 202 can aim to achieve in each monthly billing cycle for a fixed duration, such a six-month period.

To determine the target number of reward points, in one embodiment, the server system 250 uses one or more machine learning (ML) based algorithms. The ML based algorithms enable identification of a pattern of payment card related spending by the user 202. In one illustrative example, the user 202 may indulge in payment card transactions for purchasing groceries, for paying utility bills, for dining out, and the like, every month. A pattern of such spending using the payment card may be identified by the server system 250 using the ML based algorithms. Further, such algorithms enable prediction of the at least one reward point target capable of being earned by the user 202 based on the identified pattern of payment card related spending.

Each reward point target is associated with an accompanying award. For example, earning 300 reward points every month for six months may be associated with an award of 200 bonus reward points, whereas earning 350 reward points every month for six months may be associated with an award of 230 bonus reward points.

At 224, the server system 250 provides the one or more options with corresponding reward point targets to the user 202 for user selection.

At 226, the user 202 provides a selection of an option from among the one or more options provided to the user 202 for the user selection.

At 228, the server system 250 requests the user 202 to verify information related to the user's payment card and facilitate registration to the RRD offer. For example, the information related to the payment card such as for example, the payment card number, payment card expiry details, Card Verification Value associated with the payment card, and the like, may be verified. To that effect, the user may be presented with form fields and the user may be requested to provide an input related to the payment card to facilitate verification of the payment card information.

Subsequent to the successful verification, at 230, the server system 250 stores the user selection along with user payment card information in the database 206. In at least some embodiments, where the server system 250 corresponds to the payment server 140, the server system 250 may perform a verification of the payment card information and the personal identification number (PIN) with the issuer server 135 and generate a request to block the award for the user 202.

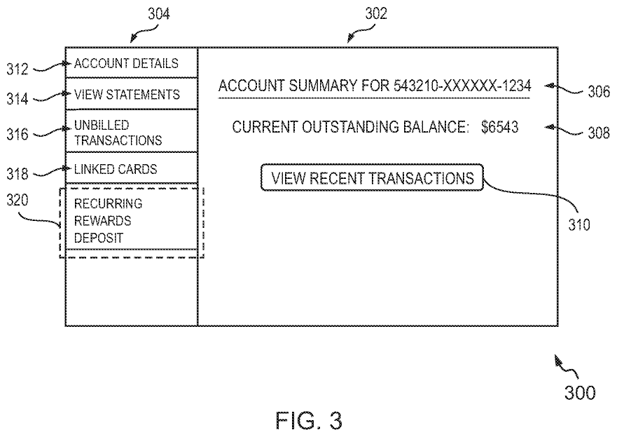

FIG. 3 shows a representation of a UI 300 associated with a user payment account for illustrating an example recurring rewards deposit (RRD) offer displayed to the user, in accordance with an example embodiment of the present disclosure.

As explained with reference to FIGS. 1 and 2, the RRD offer provides the user with a chance to earn awards, such as bonus reward points. More specifically, the RRD offer requests the user to provide a commitment to achieve a reward point target in return of an award. The reward point target is to be achieved in each future preset interval for a predefined time duration. If the user provides a selection of the RRD offer, the user provides a commitment to achieve the reward point target in each future preset interval for a predefined time duration. If the user is able to achieve the reward point target in each preset interval for the predefined duration of time, then the award such as the bonus reward points is credited to the user's payment account. If the user is unable to achieve the reward point target in each preset interval for the predefined duration of time, then the user is not entitled to the award and as such, no bonus reward points are credited to the user's payment account.

The UI 300 corresponds to a user interface (UI) associated with the user's payment account. In the illustrative example shown in FIG. 3, the payment account corresponds to an account associated with a credit card of the user. In some embodiments, the UI 300 may correspond to a Website associated with the payment card interchange network, such as for example Mastercard® interchange network (i.e. a Website associated with Mastercard International Incorporated®) or a Website associated with a credit card issuing bank, also referred to herein as an issuer. The UI 300 may be presented to the user subsequent to user login into the payment account, i.e. the credit card account. The UI 300 is depicted to include a content portion 302 and a menu portion 304.

The content portion 302 is exemplarily depicted to display a header 306 associated with text ‘Account summary for 543210-XXXXXX-1234’, or more specifically, account summary of a payment account associated with a user's payment card, or more specifically a credit card associated with number 543210-XXXXXX-1234, where X corresponds to a positive integer. The account summary is depicted to display a current outstanding balance 308 (exemplarily depicted as $6,543) and an option 310 displaying text ‘View Recent Transactions’. The user may provide a selection of the option 310 to view recent purchase transactions executed by the user using the payment card ending 1234.

The menu portion 304 is depicted to display several menu options, such as options 312, 314, 316, 318 and 320 associated with text ‘Account Details’, ‘View Statements’, ‘Unbilled Transactions’, ‘Linked Cards’ and ‘Recurring Rewards Deposit’, respectively. The user may provide a click input or a touch input on the option 320 (exemplarily depicted in a dotted box) to provide a selection of the RRD offer. The selection of the option 320 is indicative of a user commitment to achieve a reward point target in each future preset interval for a predefined time duration.

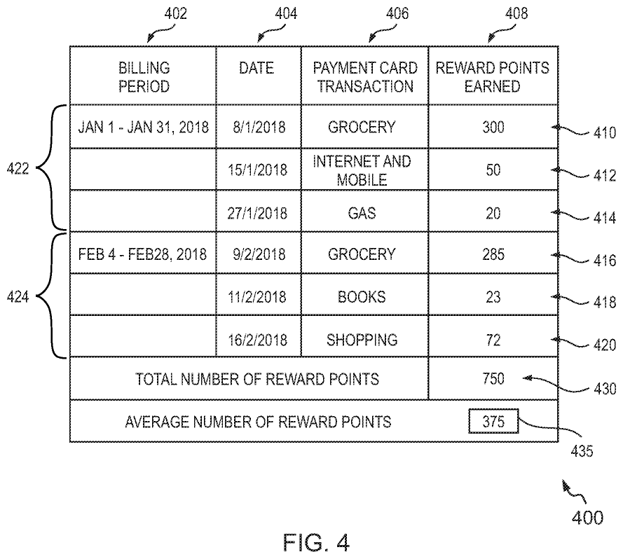

In at least one example embodiment, after the selection of the RRD offer, the server system 250 is configured to use information related to the user's payment card to retrieve payment card transactions previously executed by the user. As explained with reference to FIG. 3, the user may login to a payment account to access the RRD offer. The information related to the payment card associated with the user may be linked to the payment account. Upon successful login by the user, the payment card information may be identified by the server system 250. The information related to the user's payment card may then be used to retrieve payment card transactions previously executed by the user from an associated database, such as the database 206 shown in FIG. 2. The history of payment card transactions, or more specifically the payment card transactions previously executed by the user, is used to determine an estimate of reward points earned in a preset interval by a user. The estimate of the reward points earned in the preset interval is indicative of how many reward points the user usually accumulates in a given time period. An example determination of the estimate of reward points is explained with reference to FIG. 4.

FIG. 4 shows a simplified representation 400 of a listing of payment card transactions previously executed by the user for illustrating a determination of estimate of reward point earned in a preset interval, in accordance with an example embodiment of the present disclosure. The simplified representation 400 of payment card transactions is depicted in tabular form for illustration purposes. The history of payment card transactions may be retrieved in any form, such as comma separated value (CSV) form, a tab separated form, and the like.

The tabular form including the listing of payment card transactions is depicted to include four columns 402, 404, 406 and 408 associated with titles ‘BILLING PERIOD’, ‘DATE’, ‘PAYMENT CARD TRANSACTION’ AND ‘REWARD POINTS EARNED’, respectively. The tabular form is further depicted to include a plurality of rows, such as rows 410, 412, 414, 416, 418 and 420. The entries shown in the rows 410, 412, and 414 are related to a first preset interval, whereas the entries in the rows 416, 418, and 420 are related to a second preset interval. The preset interval is exemplarily chosen to be a monthly billing cycle period for purposes of illustration. Accordingly, the tabular form is exemplarily depicted to display two preset intervals, a preset interval 422 corresponding to monthly billing cycle period from Jan. 1, 2018 to Jan. 31 2018, and a preset interval 424 corresponding to monthly billing cycle period from Feb. 1, 2018 to Feb. 28, 2018. Each preset interval is associated with respective payment card transactions. For example, in the preset interval 422, i.e. monthly billing cycle period from Jan. 1, 2018 to Jan. 31, 2018, the user is depicted to have executed three payment card transactions for ‘GROCERY’, ‘INTERNET AND MOBILE’ AND ‘GAS’ as shown by entries in the rows 410, 412 and 414 corresponding to the column 406. Further, the reward points earned for each of these payment card transactions are shown using entries in the rows 410, 412, 414 corresponding to the column 408. More specifically, the user is depicted to have earned 300, 50 and 20 reward points for the payment card transactions related to ‘GROCERY’, ‘INTERNET AND MOBILE’ AND ‘GAS’ in the preset interval 422. Similarly, the user is depicted to have earned ‘285’, ‘23’ and ‘72’ reward points for the payment card transactions related to ‘GROCERY’, ‘BOOKS’ AND ‘SHOPPING’ in the preset interval 424.

In at least one example embodiment, the server system 250 is configured to compute a total number of reward points in the preset intervals 422 and 424 (i.e. sum of entries in the rows 410 to 420 corresponding to the column 408). The total number of reward points earned in the two preset intervals 422 and 424 is shown as entry 430, i.e. 750 reward points. The server system 250 is further configured to compute an average number of reward points earned per preset interval, as depicted as entry 435, i.e. ‘375’. In at least one example embodiment, the average number of reward points earned by the user in a preset interval may be considered as the estimate of reward points earned by the user in a preset interval. Accordingly, for the purposes of this example, the estimate of reward points may be determined to be 375 as shown by the entry 435.

It is noted that the history of payment transactions is depicted to be limited to last two monthly billing cycle periods for illustration purposes. In at least some embodiments, the payment transactions previously executed by the user may be retrieved from the time of activation of the payment card. Alternatively, payment card transactions in the last 12 or 24 monthly billing cycle periods may also be considered for determining the estimate of reward points earned by the user in a preset interval. It is noted that the term ‘determining the estimate of reward points earned in a preset interval’ implies determining a number of reward points that the user generally earns in a fixed or preset interval, such as the monthly billing cycle period. Further, the tabular form depicts three transactions performed in each of the two monthly billing cycle periods for illustration purposes. It is noted that each monthly billing cycle period may include multiple entries of payment card transactions which are more or fewer than those depicted in the simplified representation 400. Further, it is noted that the averaging of reward points is described herein for illustration purposes. In some embodiments, the server system 250 may be configured to identify seasonal variations in reward points accrual and perform a weighted average to determine the estimate of reward points earned by the user in a preset interval.

In order to encourage the user to perform more payment card transactions than usual, in one example embodiment, the server system 250 generates at least one option, where each option is associated with a respective reward point target and a predetermined award for achieving the respective reward point target. The one or more options are generated based at least in part on the estimate of reward points typically earned by the user in a preset interval. More specifically, the options are generated in such a manner that the respective reward point targets are greater than the estimate of reward points typically earned by the user in a preset interval to encourage additional payment card transactions.

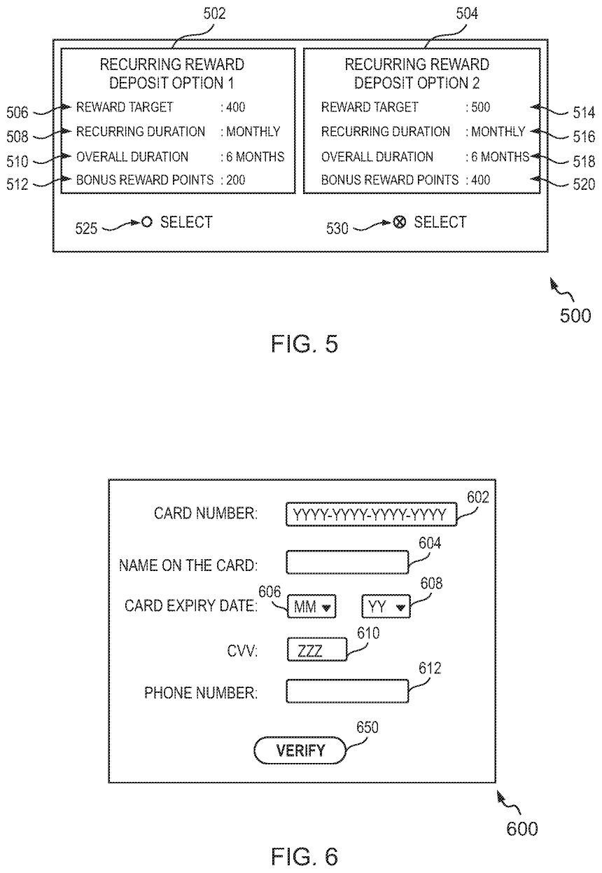

Furthermore, the reward point target is to be achieved by the user in each future preset interval for a predefined time duration. For example, the server system 250 determines one or more targets for reward points that the user can aim to achieve in each monthly billing cycle period for a fixed duration, such as six months for instance. To determine the target number of reward points, in one embodiment, the server system 250 uses one or more ML based algorithms. The ML based algorithms include both ML and artificial intelligence (AI) models that enable identification of a pattern of payment card related spending by the user 202. Further, such algorithms enable prediction of the at least one reward point target capable of being earned by the user 202 based on the identified pattern of payment card related spending. In an illustrative example, the user may have used the payment card to perform transactions for routine purchases, like those related to utilities, mobile bill, gas and groceries. Further, the user may also have occasionally used the payment card to purchase movie tickets, books or magazines, for online shopping etc. Based on such a pattern of spending, the ML based algorithms may determine that if the user performs at least two additional payment card transactions, like the occasional purchases mentioned above, in addition to the routine payment card transactions for groceries, utilities, etc., a number of reward points earned by the user can be increased by 50%. For example, if the estimate of reward points earned by the user is 200, then by performing at least two payment card transactions like the historic occasional purchases in addition to the routine payment card transactions, the user may earn 300 reward points per monthly billing cycle period (i.e. an increase of 50%). The ML based algorithms may further be configured to predict a target number of reward points that can be earned by the user using the new spending pattern. Further, suitable incentives like awards for achieving the reward point targets may also be determined after performing a cost-benefit analysis for both the payment card issuer and the user using the ML based algorithms. For example, earning 300 reward points every month for six months may be associated with an award of 200 bonus reward points, whereas earning 350 reward points every month for six months may be associated with an award of 230 bonus reward points. Accordingly, the server system 250 may be configured to generate one or more options related to reward point targets and corresponding awards. In one embodiment, the server system 250 is further configured to provide the one or more options with corresponding reward point targets to the user for user selection. An example provisioning of the options to the user for user selection is shown in FIG. 5.

FIG. 5 shows a simplified representation of a UI 500 illustrating two options related to reward point targets presented to a user, in accordance with an example embodiment of the present disclosure. As explained with reference to FIGS. 3 and 4, subsequent to the selection of the RRD offer by the user, the server system 250 determines the estimate of the reward points earned by the user in a preset interval and also generates options for reward point targets to encourage the user to actively work towards accumulating reward points.

The UI 500 may be displayed to the user on the user's electronic device subsequent to the selection of the option 320 (shown in FIG. 3). The UI 500 depicts two options, i.e. option 502 and option 504, associated with titles ‘RECURRING REWARD DEPOSIT OPTION 1’ and ‘RECURRING REWARD DEPOSIT OPTION 2’.

The option 502 is depicted to be associated with a reward point target 506 (shown as ‘REWARD TARGET’), a preset interval 508 (shown as ‘RECURRING DURATION’), a predefined time duration 510 (shown as ‘OVERALL DURATION’) and a predetermined award 512 (shown as ‘BONUS REWARD POINTS’). The reward point target 506 for the option 502 is depicted to be 400 reward points. The preset interval 508 and the predefined time duration 510 for the option 502 are depicted to be ‘MONTHLY’ and ‘6 MONTHS’, respectively, whereas the predetermined award 512 is depicted to be ‘200’ bonus reward points.

Similarly, the option 504 is depicted to be associated with a reward point target 514 (shown as ‘REWARD TARGET’), a preset interval 516 (shown as ‘RECURRING DURATION’), a predefined time duration 518 (shown as ‘OVERALL DURATION’) and a predetermined award 520 (shown as ‘BONUS REWARD POINTS’). The reward point target 514 for the option 504 is depicted to be 500 reward points. The preset interval 516 and the predefined time duration 518 for the option 504 are depicted to be ‘MONTHLY’ and ‘6 MONTHS’, respectively, whereas the predetermined award 520 is depicted to be ‘400’ bonus reward points.

Each option is depicted to be depicted to be associated with a button capable of receiving a selection input. For example, the option 502 is depicted to be associated with a button 525 and the option 504 is depicted to be associated with button 530. The buttons 525 and 530 are further depicted to be associated with text ‘Select’. The user may provide a click or a touch input to provide a selection of an option. It is noted that the UI 500 may be configured to receive a selection of only option from among the options 502 and 504 at a time. It is noted that two options are shown herein for illustration purposes and may not be considered to be limiting the scope of the description. It is noted that the server system 250 may generate a plurality of such options. Further each option may be associated with different reward point targets and different awards. It is noted that the reward point target is chosen to be greater than the estimate of reward points to motivate the user to engage in more payment card transactions than usual. In FIG. 5, the user is exemplarily depicted to have provided a selection of the option 504 by clicking on the button 530. Accordingly, the user, by way of selection of the option 504, commits to achieving 500 reward points in every future monthly billing cycle period for a period of six months. In an embodiment upon selection of the option, in at least one example embodiment, the server system is configured to cause display of another UI configured to facilitate verification of payment card information associated with the user. An example UI facilitating verification of the user' payment card information is shown in FIG. 6.

Referring now to FIG. 6, an example representation of a UI 600 provisioned to the user for verification of user's payment card information is shown, in accordance with an example embodiment of the present disclosure. As explained with reference to FIG. 5, the user may provide a selection of an option, such as the option 504, by selecting the button 530 shown in FIG. 5. The selection of the reward point related option confirms the user's commitment to achieving 500 reward points in every future monthly billing cycle period for a period of six months. In response to the selection of the option 530, the server system 250 may cause display of an UI, such as the UI 600, on an electronic device associated with the user. The UI 600 is configured to facilitate verification of the payment card information for registering the user for the RRD offer.

In one embodiment, the UI 600 is depicted to display a plurality of form fields, such as form fields 602, 604, 606, 608 and 610 for receiving input related to the user' payment card. Each form field from among the form fields 602-610 is capable of receiving user input, such as a text input or a selection input. For example, the form field 602 is depicted to be associated with text ‘CARD NUMBER’. The user may provide a 16-digit numerical input corresponding to the number of the payment card in the form field 602. In one embodiment, the form field 602 may be capable of receiving input in form of ‘YYYY-YYYY-YYY-YYYY’, where ‘Y’ corresponds to a positive integer. In one embodiment, the user may sequentially input the digits of the payment card number and the form field 602 may be configured to align the numbers in the form, depicted above. In some embodiments, the UI 600 may also include another form field, such as the form field 602, requesting the user to reconfirm the payment card number and the UI 600 may be configured to display an error if the payment card number entered in the two form fields do not match.

The form field 604 is depicted to be associated with text ‘NAME ON THE CARD’ and the borrower may provide a string of alphabets corresponding to the name of the user displayed on the payment card in the form field 604. The form fields 606 and 608 are depicted to be associated with text ‘CARD EXPIRY DATE’, and the user may provide a selection input corresponding to the month and year of the expiry of the payment card displayed on the payment card in the form fields 606 and 608, respectively.

The form field 610 is depicted to be associated with text ‘CVV’. The form field 610 may be configured to receive a 3-digit numerical input corresponding to the Card Verification Value (CVV) of the payment card. In one embodiment, the form field 610 may be capable of receiving user input in form of ‘ZZZ’, where ‘Z’ corresponds to a positive integer.

The UI 600 further depicts a form field 612 associated with text ‘PHONE NUMBER’. The form field 612 is configured to receive a ten-digit numerical input corresponding to a phone number associated with the user.

The user may select a button 650 exemplarily depicted to display text ‘VERIFY’ to provide confirmation of the information included in the form fields 602-612. Upon selection of the button 650. The server system 250 is configured to communicate with card issuer (or the issuer server 135) over a communication network, such as the network 150 explained with reference to FIG. 1, to validate the payment card information. In scenarios, where the verification of the payment card information is unsuccessful, the user may be asked to retry providing the information in the form fields 602-612 and upon subsequent failure of the verification process, the user registration to the RRD offer may be declined.

In scenarios, where the verification of the user payment card information is successful, an authentication of the user identity is performed. The authentication may be performed using a personal identification number (PIN) or any such means. In some embodiments, the user may be requested to provide a one-time password (OTP) to complete the verification as well authenticate an identity of the user for registering to the RRD offer. The OTP may be provided on the different device or a different channel (for example, a SMS channel) then the device/channel used for displaying the UI 500, so as to enable two-factor authentication of the user. In one illustrative example, the OTP may be provided on the phone number entered by the user in the form field 612. On successful matching of the OTP, the verification of the information may be completed. In at least some embodiments, where the server system 250 corresponds to the payment server 140, the server system 250 may perform a verification of the payment card information and the personal identification number (PIN) with the issuer server 135 and generate a request to block the predetermined award (for example, 400 bonus reward points associated with the option 504) for the user.

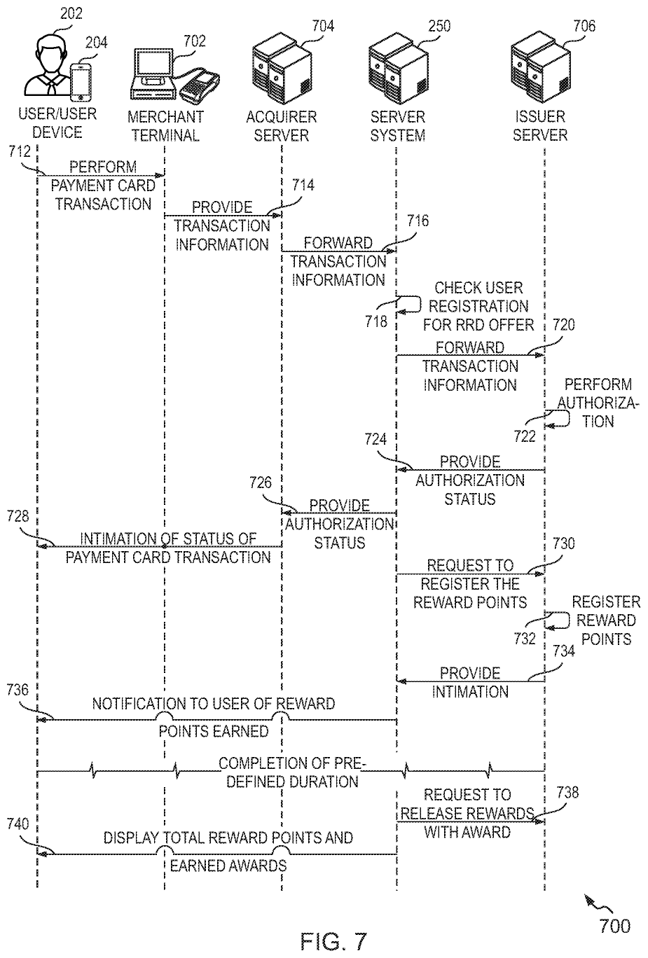

Subsequent to the user registration, the server system 250 tracks reward points earned in each future preset interval by the user for the predefined time duration. Further, the server system 250 is configured to credit the respective predetermined award, such as for example the predetermined number of bonus reward points, associated with the selected option to a payment account associated with the user if the user has achieved the reward point target associated with the selected option in each future preset interval for the predefined time duration. A sequence flow illustrating the crediting of the award, such as the bonus reward points to the user's payment account is explained next with reference to FIG. 7.

FIG. 7 represents a sequence flow diagram 700 for illustrating the server system 250 facilitating crediting of the predetermined award to the user's payment account subsequent to the user achieving the reward point target, in accordance with an example embodiment of the present disclosure. In the illustrative example explained with reference to FIG. 7, the server system 250 corresponds to the payment server (shown in FIG. 1). In some embodiments, the server system 250 may correspond to the issuer server 135 or the acquirer server 130 explained with reference to FIG. 1. In some example scenarios, the issuer server 135, the acquirer server 130 and the payment server 140 can be a single entity, or any two of these servers may be a single entity, configuring the server system 250.

Subsequent to the registration by the user 202 for the RRD offer such as the user registration as explained with reference to FIG. 2, the user 202 may perform payment card transactions, such as the payment card transaction at 712. More specifically, at 712, a user 202 performs a payment card transaction at a merchant facility, such as the facility 105 shown in FIG. 1. Accordingly, the user 202 uses a merchant terminal 702 (exemplarily depicted to be a POS terminal) to provide payment card details for the purchase transaction. At 714, the merchant terminal 702 may be configured to provide transaction information, such as for example the transaction amount and the payment card information, to a merchant bank or the acquirer. In at least some embodiments, an acquirer 704 server is configured to receive the transaction information on behalf of the acquirer. The acquirer server 706 as shown herein corresponds to the acquirer server 130 as explained with reference to FIG. 1 and.

At 716, the acquirer server 704 forwards the transaction information to the server system 250 (i.e. the payment server 140).

At 718, the server system 250 is configured to check if the user 202 is registered for the RRD offer and determine the reward points for the current transaction.

At 720, the server system 250 is configured to forward the transaction information to an issuer server 706 associated with the payment card issuing bank or the issuer. The issuer server 706 as shown herein corresponds to the issuer server 135 as explained with reference to FIG. 1.

At 722, the issuer server 706 is configured to perform an authorization of the payment card transaction. The authorization of the payment card transaction may be performed as explained with reference to FIG. 1 and is not explained herein.

At 724, the issuer server 706 intimates the status of the authorization, i.e. whether the authorization was successful or not, to the server system 250. The server system 250 is configured to relay the intimation to the acquirer server 704 at 726.

At 728, the acquirer server 704, using the merchant terminal 702, provides an intimation of the success of the payment card transaction to the user 202.

At 730, the server system 250 provisions a request to register the reward points earned corresponding to the payment card transaction to the issuer server 706.

At 732, the issuer server 706 is configured to block the rewards points against the recent payment card transaction of the user and, provide an intimation to the server system at 734.

At 736, the server system 250 notifies the user 202 of the earned reward points and the user's progress towards the RRD offer.

The user 202 may continue to perform payment card transactions in each preset interval for the predefined time duration to meet the reward point target selected by the user.

After completion of the predefined time duration, at 738, the server system 250 is configured to provision a request to the issuer server 706 to release the rewards and add the predetermined award if the user has achieved the reward point target in each preset interval for the predefined time duration.

At 740, the server system 250 causes display of the earned reward points along with the total number of reward points to the user 202. As explained with reference to FIG. 2, the user 202 may use the electronic device 204 to access a payment account associated with the user's payment card. The reward points credited to the user's payment account may be viewed on the UI associated with the user's payment account.

The earned bonus reward points may help the user to reach the reward point milestones faster. After reaching the reward point milestones, the user 202 may then redeem the reward points towards eligible awards. In at least some embodiments, the server system 250 may be configured to display options for reward point redemption. For example, various products and/or services that the user can avail such as for example, consumer electronics, personal care products, movie tickets, sporting equipment, etc. may be purchased by exchanging reward points available in the user's payment account.

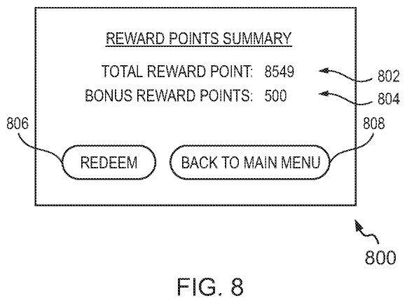

FIG. 8 shows a simplified representation of a UI 800 displaying a status of reward points in the user's payment account, in accordance with an example embodiment of the present disclosure. The UI 800 may be displayed to the user subsequent to the completion of the predefined time duration. As explained with reference to FIGS. 1 and 7, the user may be provided with an offer to commit to achieving a target number of reward points in each preset interval for a predefined duration. After user acceptance of the offer, the user may be provided with options for selecting reward point targets. Each option is associated with corresponding award. The options offered to the user along with respective award of a predetermined number of bonus reward points in shown in FIG. 5. The user may select an option and commit to achieving the reward point target in each future preset interval for predefined time duration. Accordingly, the user may engage in payment card transactions to meet the reward point target. After the completion of the predefined time duration, if the user has achieved the reward point target in each preset interval for the predefined duration of time, then the server system 250 (shown in FIG. 2) may be configured to facilitate crediting of the award, for example, a fixed number of bonus reward points to the user's payment account.

The user upon access of the payment account may request to view the reward point balance in the payment account. The server system 250 may be configured to retrieve the corresponding information from an associated database (such as the database 206 shown in FIG. 2), and present the information in form a UI, such as the UI 800.

The UI 800 depicted to display two text entries 802 and 804 associated with text snippets ‘TOTAL REWARD POINTS’ and ‘BONUS REWARD POINTS’, respectively. Each text entry is associated with a numerical value indicative of the reward point numbers. For example, the text entry 802 is associated with a value 8549 indicating that the user has 8549 total reward points in the payment account. The text entry 804 is associated with a value 500 indicating that the user has earned 500 bonus reward points as an award for achieving the reward point target in each preset interval for the predefined time duration. The UI 800 further depicts two buttons 806 and 808 associated with text ‘REDEEM’ and ‘BACK TO MAIN MENU’, respectively. The user may provide a selection of the button 806 to view another UI showing reward point milestones and eligible purchases for each reward point milestone. The selection of the button 808 may revert the user to an UI, such as the UI 300 shown in FIG. 3.

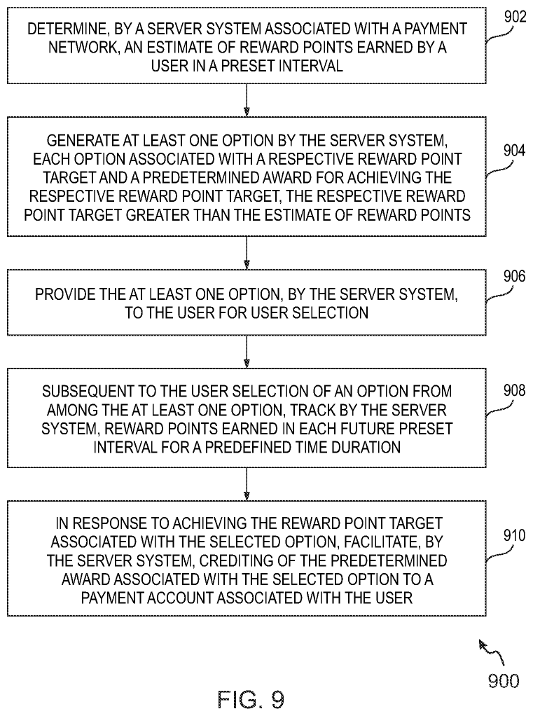

FIG. 9 illustrates a flow diagram of a method 900 for facilitating earning of reward points on payment card transaction by users, in accordance with an example embodiment of the present disclosure. The method 900 depicted in the flow diagram may be executed by, for example, the at least one server system such as the acquirer server 130, the issuer server 135 and the payment server 140 explained with reference to FIG. 1. Operations of the flow diagram 900, and combinations of operation in the flow diagram 900, may be implemented by, for example, hardware, firmware, a processor, circuitry and/or a different device associated with the execution of software that includes one or more computer program instructions. The operations of the method 900 are described herein with help of the server system associated with a payment network, such as for example the payment server 140. It is noted that the operations of the method 900 can be described and/or practiced by using other server systems, such as the acquirer server 130 and the issuer server 135. The method 900 starts at operation 902.

At 902, the method 900 includes determining, by a server system associated with a payment network, an estimate of reward points earned by a user in a preset interval. As explained with reference to FIGS. 1 to 7, in order to encourage the users to actively engage in accumulating reward points on payment card transactions, users may be provided with an offer, also referred to herein as the recurring rewards deposit (RRD) offer, for user selection. The RRD offer requests the user to provide a commitment to achieve a target number of reward points in return of an award. The target number of reward points is to be achieved in each future preset interval for a predefined time duration. The term ‘each future preset interval’ as used herein may imply a fixed time interval, such as a monthly billing cycle period for instance. A non-limiting example of a predefined time duration may be a duration of six months. Accordingly, in an illustrative example, by selecting the RRD offer, the user may commit to achieving a fixed number (i.e. a target number) of reward points in every monthly billing cycle for six months and, in return, the user will receive an award, such as for example a predetermined number of bonus reward points.

After the selection of the RRD offer, the server system is configured to use information related to the user's payment card to retrieve payment card transactions previously executed by the user. The history of payment card transactions is used to determine an estimate of reward points earned in a preset interval by a user. The estimate of the reward points earned in the preset interval is indicative of how many reward points the user usually accumulates in a given time period. The determination of the estimate of the reward points may be performed as explained with reference to FIG. 4 and is not explained again herein.

At 904, the method 900 includes generating at least one option by the server system based at least in part on the estimate of reward points. Each option is associated with a respective reward point target and a predetermined award for achieving the respective reward point target. The reward point target associated with each generated option is purposefully chosen to be greater than the estimate of reward points to encourage additional payment card transactions. Furthermore, the reward point target is to be achieved by the user in each future preset interval for a predefined time duration. For example, the server system determines one or more targets for reward points that the user can aim to achieve in each monthly billing cycle period for a fixed duration, such a six-month period.

To determine the target number of reward points, in one embodiment, the server system uses one or more machine learning based algorithms. The term ‘machine learning algorithms’ as used herein may include both machine learning (ML) and artificial intelligence (AI) models. The one or more ML based algorithms are configured to enable identification of a pattern of payment card related spending by the user. Further, such algorithms enable prediction of the at least one reward point target capable of being earned by the user based on the identified pattern of payment card related spending. The generation of the options may be performed as explained with reference to FIGS. 4 and 5.

At 906, the method 900 includes providing the at least one option to the user for user selection by the server system. In an illustrative example, the server system may have identified two possible options for reward point targets that the user can achieve. For example, if a user can achieve 300 or 350 reward points, then the server system may provide both of these reward point targets to the user as options for user selection. Each reward point target is associated with an accompanying award. For example, earning 300 reward points every month for six months may be associated with an award of 200 bonus reward points, whereas earning 350 reward points every month for six months may be associated with an award of 230 bonus reward points. The user may provide a selection of one option from among the reward point target related options presented to the user. The provisioning of the options to the user may be performed as depicted in FIG. 5.

In some embodiments, the user may be requested to verify information related to the user's payment card and thereby register for the RRD offer. The verification of the payment card information and the subsequent registration to the RRD offer may be performed as explained with reference to FIG. 6.

At 908, the method 900 includes tracking reward points earned in the each future preset interval for the predefined time duration by the server system subsequent to the user selection of an option from among the at least one option. At 910, the method 900 includes facilitating, by the server system, crediting of the predetermined award associated with the selected option to a payment account associated with the user in response to achieving the reward point target associated with the selected option in the each future preset interval for the predefined time duration. The crediting of the award, such as for example a predetermined number of bonus reward points may be performed as explained with reference to sequence flow 700 in FIG. 7.

In one embodiment, the server system causes display of a total number of reward points and earned predetermined number of bonus reward points earned by the user after the completion of the predefined time duration. The display of the reward point balance may be performed as explained with reference to FIG. 8. Furthermore, the server system may facilitate redemption of at least a portion of the total number of reward points after the crediting of the bonus reward points in the user's payment account.

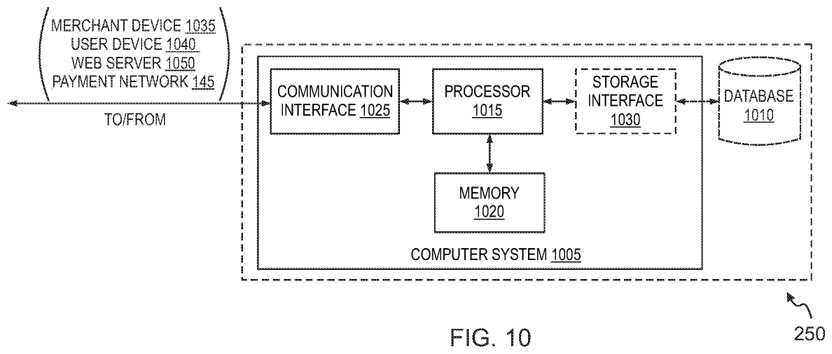

FIG. 10 is a simplified block diagram of a server system 250 used for facilitating earning of reward points on payment card transactions by users, in accordance with an example embodiment of the present disclosure. The server system 250 is an example of a server system that is a part of the payment network 145. Examples of the server system 250 includes, but not limited to, the acquirer server 130, the issuer server 135 and the payment server 140. The server system 250 includes a computer system 1005 and a database 1010. It is noted that in some embodiments, the database 1010 may not be included as a part of the server system 250 and as such, the server system may only include the computer system 1005 operatively coupled to the database 1010 over a network, such as the network 150 shown in FIG. 1. The database 1010 may be example of the database 206 explained with reference to FIG. 2.

The computer system 1005 includes at least one processor 1015 for executing instructions. Instructions may be stored in, for example, but not limited to, a memory 1020. The processor 1015 may include one or more processing units (e.g., in a multi-core configuration).

The processor 1015 is operatively coupled to a communication interface 1025 such that the computer system 1005 is capable of communicating with a remote device such as a merchant device 1035 (e.g., the POS terminal 125), a user device 1040 (e.g., the user device 204 shown in FIG. 2), a Web server 1050 hosting the Web pages associated with UIs corresponding to the user's online payment account, or any entity within the payment network 145. For example, the communication interface 1025 may enable provisioning of an offer, such as the RRD offer, to a user using a UI, such as the UI 300 shown in FIG. 3. Similarly, the communication interface 1025 enables provisioning of options for reward point targets, such as the options 502 and 504 shown in FIG. 5. Further, the communication interface 1025 is also configured to receive information provided by the user on a UI, such as the UI 600, shown in FIG. 6, from the Web server 1050 hosting the user's payment account, via the Internet and facilitate verification of the payment card information provided by the user.

The processor 1015 may also be operatively coupled to the database 1010. The database 1010 is any computer-operated hardware suitable for storing and/or retrieving data, such as, but not limited to, transaction data generated as part of sales activities conducted over the bankcard network including data relating to merchants, account holders or customers, and purchases. The database 1010 may also store information related to a plurality of user's payment accounts. Each payment account data includes at least one of a user name, a user address, payment card related information, PIN, and other account identifiers. The database 1010 may also store merchant data including a merchant identifier that identifies each merchant registered to use the payment network 145, and instructions for settling transactions including merchant bank account information (e.g., a plurality of payment accounts related to POS terminals associated with merchants).

The database 1010 is further configured to store a plurality of machine learning (ML) based algorithms. The ML based algorithms enable identification of patterns of payment card related spending by the users. Further, such algorithms enable prediction of reward point targets capable of being earned by the users based on the respective identified pattern of payment card related spending. The database 1010 is also configured to store records of users who have opted for the recurring rewards deposit (RRD) offer and a number of reward points earned by the users per preset interval.

The database 1010 may include multiple storage units such as hard disks and/or solid-state disks in a redundant array of inexpensive disks (RAID) configuration. The database 1010 may include a storage area network (SAN) and/or a network attached storage (NAS) system. In some embodiments, the database 1010 is integrated within the computer system 1005. For example, the computer system 1005 may include one or more hard disk drives as the database 1010. In other embodiments, the database 1010 is external to the computer system 1005 and may be accessed by the computer system 1005 using a storage interface 1030. The storage interface 1030 is any component capable of providing the processor 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1015 with access to the database 1010.

The computer system 1005 in conjunction with the database 1010 is configured to perform the various function as explained with reference to the server system 250 in FIGS. 2 to 8. For example, the processor 1015 of the computer system 1005 is configured to determine an estimate of reward points earned by the user in a preset interval. The processor 1015 is further configured to use machine learning based algorithms to predict reward point targets that can be earned by the user and generate options including reward point targets and corresponding awards. The processor 1015 is also configured to provide the options to the user and subsequent to the selection of an option by the user, track the reward points earned by the user in each future preset interval. Moreover, after completion of the predefined time duration, the processor 1015 is configured to facilitate crediting of the predetermined award associated with the selected option in the user's payment account.

Furthermore, the processor 1015 is configured to cause display of an UI showing a total number of reward points in the user's payment account along with the earned reward points to the user. In some embodiments, the processor 1015 is configured to facilitate redemption of at least a portion of the reward points in the user's payment account.

FIG. 11 is a simplified block diagram of a POS terminal 1100 used for a payment card transaction, in accordance with an example embodiment of the present disclosure. The POS terminal 1100 as explained herein is only one example of the merchant device 1035. In various embodiments, the merchant device 1035 can be a merchant mobile phone, a kiosk, a PDA, a merchant facilitated e-commerce website interface running on a computing device and the like. The POS terminal 1100 is an example of the POS terminal 125 of FIG. 1 in terms of functionalities and features. The POS terminal 1100 includes at least one processor 1105 communicably coupled to a database 1110, an Input/Output (I/O) interface 1115, a communication interface 1120 and a memory 1125. The components of the POS terminal 1100 provided herein may not be exhaustive, and that the POS terminal 1100 may include more or fewer components than that of depicted in FIG. 11. Further, two or more components may be embodied in one single component, and/or one component may be configured using multiple sub-components to achieve the desired functionalities. Some components of the POS terminal 1100 may be configured using hardware elements, software elements, firmware elements and/or a combination thereof.

The I/O interface 1115 is configured to receive inputs from and provide outputs to the end-user (i.e. the merchant and/or the customer) of the POS terminal 1100. For instance, the I/O interface 1115 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 1125 can be any type of storage accessible to the processor 1105. For example, the memory 1125 may include volatile or non-volatile memories, or a combination thereof. In some non-limiting examples, the memory 1125 can be four to sixty-four Megabytes (MB) of Dynamic Random Access Memory (“DRAM”) or Static Random Access Memory (“SRAM”). In addition, some examples may include supplementary flash memory installed via a PCMCIA slot.

The database 1110 is capable of storing and/or retrieving data, such as, but not limited to, smart card insertions, user/customer information, merchant information, card swipes, touch-screen key depressions, keypad key depressions, number of dots printed by the slip and roll printers, check read errors, QR codes, and the like. Such information can be accessed by the processor 1105 using the communication interface 1120 to determine potential future failures and the like.

The POS terminal 1100 is capable of communicating with one or more POS peripheral devices such as a POS peripheral device 1135 and external server system such as an acquirer server 1130 (an example of the acquirer server 130 of FIG. 1) via the communication interface 1120 over a communication network such as the network 150 of FIG. 1. The POS peripheral device 1135 can provide functionality which is used by a consumer at a merchant facility, such as PIN entry, clear text entry, signature capture, QR code scan, and the like. Some non-exhaustive examples of the POS peripheral device 1135 include QR code scanner, bar code scanner, cash drawer, magnetic stripe reader, receipt printer, PIN pad, signature capture device, touchscreen, keyboard, portable data terminal, card reader, and the like. In some embodiments, the POS terminal 1100 may be mounted near a cash register at a check-out counter in merchant facility, while the POS peripheral device 1135 may be mounted on the check-out counter such that it is accessible to the users. In this way, both the merchant and the user/customer can interact with similar devices to process both payment card financial transactions and card-less financial transactions.

The communication interface 1120 is further configured to cause display of user interfaces on the POS terminal 1100. In one embodiment, the communication interface 1120 includes a transceiver for wirelessly communicating information to, or receiving information from, the acquirer server 1130 or other suitable display device, and/or another type of remote processing device, such as QR code scanner. In another embodiment, the communication interface 1120 is capable of facilitating operative communication with the remote devices and a cloud server using Application Program Interface (API) calls. The communication may be achieved over a communication network, such as the network 150.

The processor 1105 is capable of sending the payment transaction request received from the end-user via the communication interface 1120 to the acquirer server 1130 for processing the payment transaction. For example, the processor 1105 is configured to receive the transaction amount entered by the end-user using the UIs. The processor 1105 can access the database 1110 to retrieve the user information and merchant information that are required to be sent along with the payment transaction request to the acquirer server 1130.

Additionally, the POS terminal 1100 can include an operating system and various software applications that can provide various functionality to the POS terminal 1100. For example, in some embodiments, the POS terminal 1100 is addressable with an Internet protocol and includes a browser application. In such embodiments, the processor 1105 includes software adapted to support such functionality. In some embodiments, the processor 1105 executes software to support network management. In particular, this capacity allows software to be downloaded to a plurality of such systems to provide new applications such as application for enabling card-less financial transactions using POS terminals and/or updates to existing applications. The operating system and software application upgrades are distributed and maintained through communication to the POS terminal 1100 over the communication network 150.

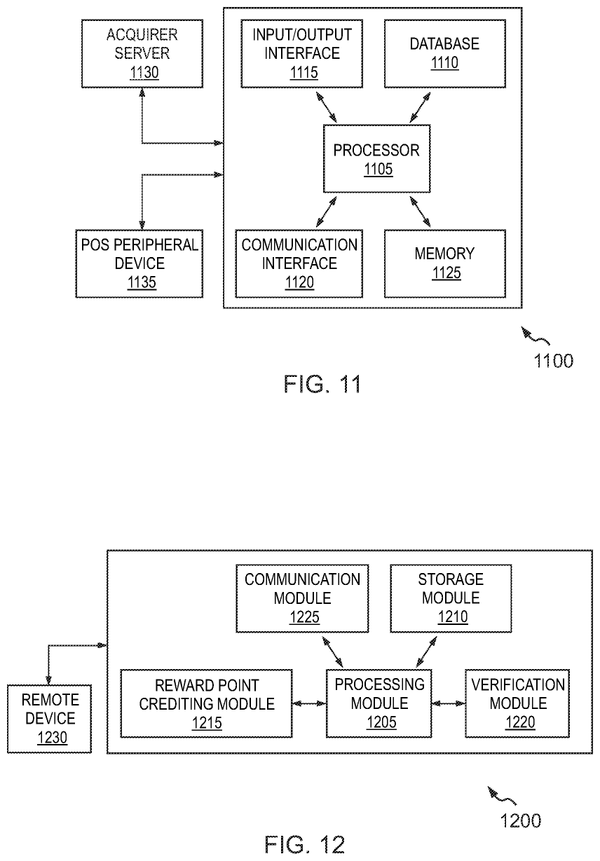

FIG. 12 is a simplified block diagram of an issuer server 1200 for facilitating earning of reward points on payment card transactions by users, in accordance with one embodiment of the present disclosure. The issuer server 1200 is an example of the issuer server 135 of FIG. 1, or may be embodied in the issuer server 135. The issuer server 1200 is associated with an issuer bank/issuer, in which a user may have an account, which provides an option to earn extra reward points on payment card transactions. The issuer server 1200 includes a processing module 1205 operatively coupled to a storage module 1210, a reward point crediting module 1215, a verification module 1220 and a communication module 1225. The components of the issuer server 1200 provided herein may not be exhaustive, and that the issuer server 1200 may include more or fewer components than that of depicted in FIG. 12. Further, two or more components may be embodied in one single component, and/or one component may be configured using multiple sub-components to achieve the desired functionalities. Some components of the issuer server 1200 may be configured using hardware elements, software elements, firmware elements and/or a combination thereof.

The storage module 1210 is configured to store machine executable instructions to be accessed by the processing module 1205. Additionally, the storage module 1210 stores information related to, contact information of the user, bank account number, BICs, payment card details, internet banking information, PIN, mobile personal identification number (MPIN) for mobile banking, user reward points, and the like. This information is retrieved by the processing module 1205 for cross-verification during payment transactions.

The processing module 1205, in conjunction with the verification module 1220, is configured to verify the payment card information, the PIN (e.g., whether the four-digit numeric code matches the PIN issued by the issuer), the sufficient funds in the user account, and the like. Upon successful verification only, the processing module 1205 in conjunction with the reward point crediting module 1315 is configured to facilitate registration of the user to the recurring rewards deposit offer. Further, the processing module 1205 in conjunction with the reward point crediting module 1215 is configured to block the bonus reward points to be credited to the user's payment account subsequent to achievement of the reward point target in each preset interval for a predefined time duration by the user.

The processing module 1205 is further configured to communicate with one or more remote devices such as a remote device 1230 using the communication module 1225 over a network such as the network 150 or the payment network 145 of FIG. 1. The examples of the remote device 1230 include, the merchant device 1035, the user device 1040, the payment server 140, the acquirer server 130, other computing systems of issuer and the payment network 145 and the like. The communication module 1225 is capable of facilitating such operative communication with the remote devices and cloud servers using API (Application Program Interface) calls.

FIG. 13 is a simplified block diagram of an acquirer server 1300 used for facilitating earning of reward points on payment card transactions by users, in accordance with one embodiment of the present disclosure. The acquirer server 1300 is associated with the acquirer bank of a merchant where the merchant has established an account to accept payment from payment card transactions performed by users. The acquirer server 1300 is an example of the acquirer server 130 of FIG. 1, or may be embodied in the acquirer server 130. Further, the acquirer server 1300 is configured to facilitate earning of reward points on payment card transactions performed by users using the payment network 145 of FIG. 1. The acquirer server 1300 includes a processing module 1305 communicably coupled to a merchant database 1310 and a communication module 1315. The components of the acquirer server 1300 provided herein may not be exhaustive, and that the acquirer server 1300 may include more or fewer components than that of depicted in FIG. 13. Further, two or more components may be embodied in one single component, and/or one component may be configured using multiple sub-components to achieve the desired functionalities. Some components of the acquirer server 1300 may be configured using hardware elements, software elements, firmware elements and/or a combination thereof.

The merchant database 1310 includes data related to merchant, such as, but not limited to, a merchant primary account number (PAN), a merchant name, a merchant category code (MCC), a merchant city, a merchant postal code, a merchant brand name, a merchant ID and the like. The processing module 1305 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices) they use for processing transactions. A merchant with a single merchant processing account number may use several terminals at one location, resulting in one merchant ID and several terminal identification numbers (TIDs). The processing module 1305 may be configured to store and update such merchant information in the merchant database 1310 for later retrieval.

In an embodiment, the communication module 1315 is capable of facilitating operative communication with a remote device 1320 (e.g., the POS terminal 1100, the issuer server 1200, the merchant device 1035 and/or the payment server 140) using API calls. The communication may be achieved over a communication network, such as the network 150. For example, the processing module 1305 may receive the payment card information and the transaction amount from the POS terminal 1100 using the communication module 1315. Further, the processing module 1305 is configured to receive the debited transaction amount from the payment server 140 or the issuer server 135 (or the issuer server 1200) using the communication module 1315. Thereafter, the processing module 1305 may retrieve merchant PAN from the merchant database 1310 to credit the transaction amount in the acquirer account of the merchant. Further, the processing module 1305 may be configured to send the transaction status to the POS terminal 1100 of the merchant.

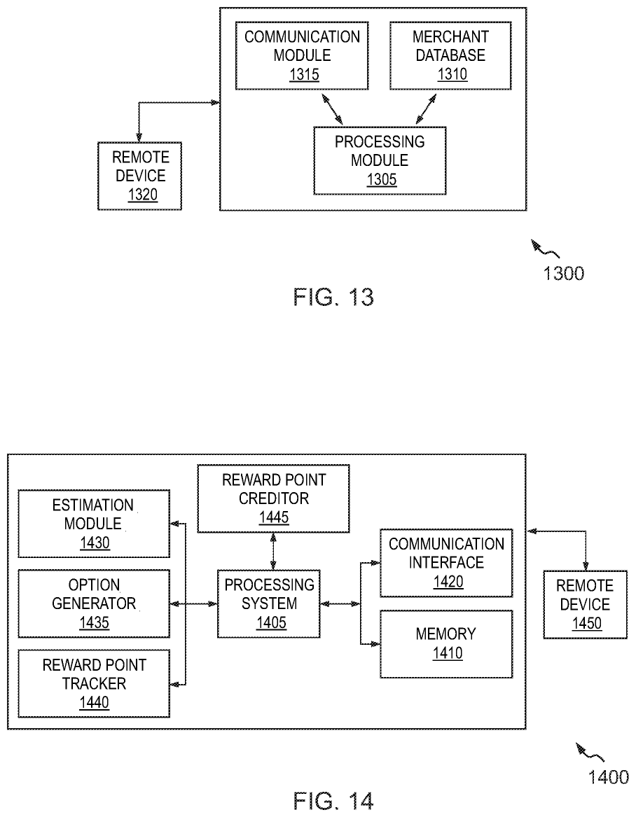

FIG. 14 is a simplified block diagram of a payment server 1400 used for facilitating earning of reward points on payment card transactions by users, in accordance with one embodiment of the present disclosure. The payment server 1400 may correspond to payment server 140 of FIG. 1. As explained with reference to FIG. 1, the payment server 140 is associated with a payment network 145. The payment network 145 may be used by the issuer server 1200 and the acquirer server 1300 as a payment interchange network. Examples of payment interchange network include, but not limited to, Mastercard® payment system interchange network. The payment server 1400 includes a processing system 1405 configured to extract programming instructions from a memory 1410 to provide various features of the present disclosure. The components of the payment server 1400 provided herein may not be exhaustive, and that the payment server 1400 may include more or fewer components than that of depicted in FIG. 14. Further, two or more components may be embodied in one single component, and/or one component may be configured using multiple sub-components to achieve the desired functionalities. Some components of the payment server 1400 may be configured using hardware elements, software elements, firmware elements and/or a combination thereof.

Via a communication interface 1420, the processing system 1405 receives the selection of the recurring rewards deposit (RRD) offer by the user. The selection of the RRD offer is indicative of the user's commitment to earn the target number of reward points in each future preset interval for a predefined time duration. For example, by selecting the RRD offer, the user may commit to achieving a fixed number (i.e. a target number) of reward points for every monthly billing cycle period for six months and, in return, the user will receive an award, such as for example a predetermined number of bonus reward points.

An estimation module 1430 performs determination of an estimate of reward points earned by the user in a preset interval. The estimation of reward points is determined based on payment card transactions previously executed by the user. The determination of the estimation of reward points earned by the user in the preset interval may be performed as explained with reference to FIG. 4.

An option generator 1435 is operatively coupled to the processing system 1405. The option generator 1435 is configured to use machine learning based algorithms to predict reward point targets that can be earned by the user and generate options including reward point targets and corresponding awards. The generated options are provided to the user by the processing system 1405 via the communication interface 1420. A reward point tracker 1440 is configured to track the reward points earned by the user in each future preset interval subsequent to the selection of an option by the user. A reward point creditor 1445 is configured to facilitate crediting of the predetermined award associated with the selected option in the user's payment account after completion of the predefined time duration, for example by requesting the issuer server 1300 to release the award subsequent to the completion of the predefined time duration.

The processing system 1405 is further configured to cause display of an UI showing a total number of reward points in the user's payment account along with the earned reward points to the user. In some embodiments, the processing system 1405 in conjunction with the reward point creditor 1445 is configured to facilitate redemption of at least a portion of the reward points in the user's payment account.

In an embodiment, a remote device 1450 may correspond to the user device 1040, the Web server 1050 hosting the user payment account, the merchant device 1035 or any other entity on the payment network 145.

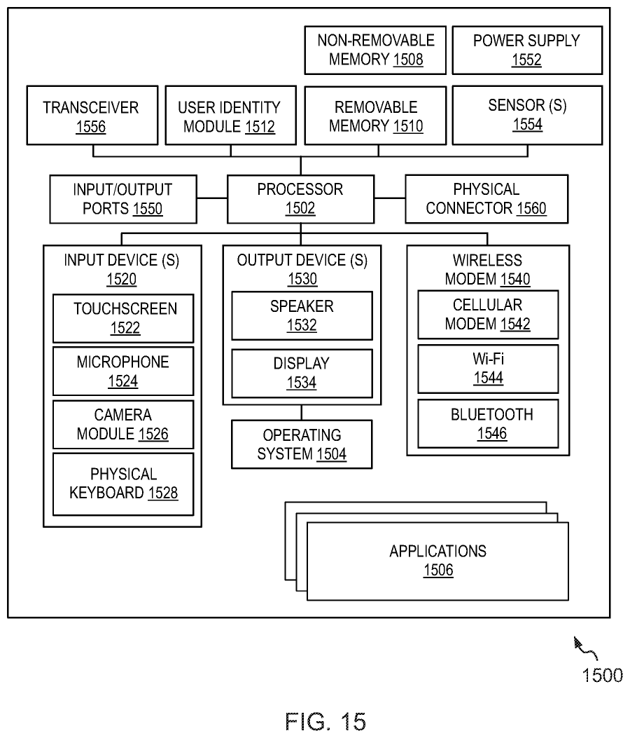

FIG. 15 shows simplified block diagram of a user device 1500 for example a mobile phone or a desktop computer capable of implementing the various embodiments of the present disclosure. For example, the user device 1500 may correspond to the user device 1040 of FIG. 11 or the user device 204 shown in FIG. 2. The user device 1500 is depicted to include one or more applications 1506.

It should be understood that the user device 1500 as illustrated and hereinafter described is merely illustrative of one type of device and should not be taken to limit the scope of the embodiments. As such, it should be appreciated that at least some of the components described below in connection with that the user device 1500 may be optional and thus in an example embodiment may include more, less or different components than those described in connection with the example embodiment of the FIG. 15. As such, among other examples, the user device 1500 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1500 includes a controller or a processor 1502 (e.g., a signal processor, microprocessor, ASIC, or other control and processing logic circuitry) for performing such tasks as signal coding, data processing, image processing, input/output processing, power control, and/or other functions. An operating system 1504 controls the allocation and usage of the components of the user device 1500 and support for one or more payment application programs (see, applications 1506), that implements one or more of the innovative features, such as earning of reward points, as described herein. In addition, the applications 1506 may include common mobile computing applications (e.g., telephony applications, email applications, calendars, contact managers, web browsers, messaging applications) or any other computing application.

The illustrated user device 1500 includes one or more memory components, for example, a non-removable memory 1508 and/or a removable memory 1510. The non-removable memory 1508 and/or the removable memory 1510 may be collectively known as database in an embodiment. The non-removable memory 1508 can include RAM, ROM, flash memory, a hard disk, or other well-known memory storage technologies. The removable memory 1510 can include flash memory, smart cards, or a Subscriber Identity Module (SIM). The one or more memory components can be used for storing data and/or code for running the operating system 1504 and the applications 1506. The user device 1500 may further include a user identity module (UIM) 1512. The UIM 1512 may be a memory device having a processor built in. The UIM 1512 may include, for example, a subscriber identity module (SIM), a universal integrated circuit card (UICC), a universal subscriber identity module (USIM), a removable user identity module (R-UIM), or any other smart card. The UIM 1512 typically stores information elements related to a mobile subscriber. The UIM 1512 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1500 can support one or more input devices 1520 and one or more output devices 1530. Examples of the input devices 1520 may include, but are not limited to, a touch screen/a display screen 1522 (e.g., capable of capturing finger tap inputs, finger gesture inputs, multi-finger tap inputs, multi-finger gesture inputs, or keystroke inputs from a virtual keyboard or keypad), a microphone 1524 (e.g., capable of capturing voice input), a camera module 1526 (e.g., capable of capturing still picture images and/or video images) and a physical keyboard 1528. Examples of the output devices 1530 may include, but are not limited to a speaker 1532 and a display 1534. Other possible output devices can include piezoelectric or other haptic output devices. Some devices can serve more than one input/output function. For example, the touch screen 1522 and the display 1534 can be combined into a single input/output device.

A wireless modem 1540 can be coupled to one or more antennas (not shown in the FIG. 15) and can support two-way communications between the processor 1502 and external devices, as is well understood in the art. The wireless modem 1540 is shown generically and can include, for example, a cellular modem 1542 for communicating at long range with the mobile communication network, a Wi-Fi compatible modem 1544 for communicating at short range with an external Bluetooth-equipped device or a local wireless data network or router, and/or a Bluetooth-compatible modem 1546. The wireless modem 1540 is typically configured for communication with one or more cellular networks, such as a GSM network for data and voice communications within a single cellular network, between cellular networks, or between the user device 1500 and a public switched telephone network (PSTN).

The user device 1500 can further include one or more input/output ports 1550, a power supply 1552, one or more sensors 1554 for example, an accelerometer, a gyroscope, a compass, or an infrared proximity sensor for detecting the orientation or motion of the user device 1500 and biometric sensors for scanning biometric identity of an authorized user, a transceiver 1556 (for wirelessly transmitting analog or digital signals) and/or a physical connector 1560, which can be a USB port, IEEE 1294 (FireWire) port, and/or RS-232 port. The illustrated components are not required or all-inclusive, as any of the components shown can be deleted and other components can be added.

The disclosed embodiments with reference to FIGS. 2 to 8, or one or more operations of the flow diagram 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 250 its various components such as the computer system 1005 and the database 1010 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
determining, by a server system associated with a payment network, an estimate of reward points earned by a user in a preset interval, the estimate determined based on payment card transactions previously executed by the user;
based at least in part on the estimate of reward points, generating at least one option by the server system, each option from among the at least one option associated with a respective reward point target and a predetermined award for achieving the respective reward point target, the respective reward point target greater than the estimate of reward points, the respective reward point target to be achieved by the user in each future preset interval for a predefined time duration;
providing the at least one option, by the server system, to the user for user selection;
subsequent to the user selection of an option from among the at least one option, tracking by the server system, reward points earned in the each future preset interval for the predefined time duration; and
in response to achieving the reward point target associated with the selected option in the each future preset interval for the predefined time duration, facilitating, by the server system, crediting of the predetermined award associated with the selected option to a payment account associated with the user.

2. The method as claimed in claim 1, further comprising:
providing, by the server system, an offer to the user, the offer requesting the user to provide a commitment to achieve a target number of reward points in the each future preset interval for the predefined time duration in return of an award, wherein the estimate of reward points is determined subsequent to a selection of the offer by the user.

3. The method as claimed in claim 2, further comprising:
facilitating, by the server system, verification of information related to a payment card associated with the user subsequent to the selection of the offer by the user, wherein the information related to the payment card is used for retrieving the payment card transactions previously executed by the user.

4. The method as claimed in claim 1, further comprising:
using, by the server system, one or more machine learning based algorithms to:
identify a pattern of payment card related spending by the user; and
predict the respective reward point target capable of being earned by the user based on the identified pattern of payment card related spending.

5. The method as claimed in claim 1, wherein the estimate of reward points corresponds to an average number of reward points earned per preset interval by the user.

6. The method as claimed in claim 1, wherein the predetermined award corresponds to a predetermined number of bonus reward points and, wherein the predetermined number of bonus reward points is credited to the payment account on achieving the reward point target associated with the selected option.

7. The method as claimed in claim 6, further comprising:
causing, by the server system, display of at least one of a total number of reward points and the predetermined number of bonus reward points earned by the user subsequent to a completion of the predefined time duration.

8. The method as claimed in claim 7, further comprising:
facilitating, by the server system, redemption of at least a portion of the total number of reward points subsequent to the crediting of the predetermined number of bonus reward points in the payment account associated with the user.

9. The method as claimed in claim 1, wherein the each future preset interval corresponds to a monthly billing cycle period.

10. A server system in a payment network, comprising:
a communication interface for receiving a selection of an offer by a user, the offer requesting the user to provide a commitment to achieve a target number of reward points in each future preset interval for a predefined time duration in return of an award;
a memory comprising stored instructions; and
a processor communicably coupled to the communication interface, the processor configured to execute the stored instructions to cause the server system to perform at least:
determine an estimate of reward points earned by the user in a preset interval, the estimate determined based on payment card transactions previously executed by the user;
based at least in part on the estimate of reward points, generate at least one option, each option from among the at least one option associated with a respective reward point target and a predetermined award for achieving the respective reward point target, the respective reward point target greater than the estimate of reward points, the respective reward point target to be achieved by the user in the each future preset interval for the predefined time duration;
provide the at least one option to the user for user selection;
subsequent to the user selection of an option from among the at least one option, track reward points earned in the each future preset interval for the predefined time duration; and
in response to achieving the reward point target associated with the selected option in the each future preset interval for the predefined time duration, facilitate crediting of the predetermined award associated with the selected option to a payment account associated with the user.

11. The server system as claimed in claim 10, wherein the server system is further caused to:
facilitate verification of information related to a payment card associated with the user subsequent to the selection of the offer by the user, wherein the information related to the payment card is used for retrieving the payment card transactions previously executed by the user.

12. The server system as claimed in claim 10, wherein the memory is configured to store one or more machine learning based algorithms capable of causing the server system to:
identify a pattern of payment card related spending by the user; and
predict the respective reward point target capable of being earned by the user based on the identified pattern of payment card related spending.

13. The server system as claimed in claim 10, wherein the estimate of reward points corresponds to an average number of reward points earned per preset interval by the user.

14. The server system as claimed in claim 10, wherein the predetermined award corresponds to a predetermined number of bonus reward points and, wherein the predetermined number of bonus reward points is credited to the payment account on achieving the reward point target associated with the selected option.

15. The server system as claimed in claim 14, wherein the server system is further configured to:
cause display of at least one of a total number of reward points and the predetermined number of bonus reward points earned by the user subsequent to a completion of the predefined time duration.

16. The server system as claimed in claim 15, wherein the server system is further caused to:
facilitate redemption of at least a portion of the total number of reward points subsequent to the crediting of the predetermined number of bonus reward points in the payment account associated with the user.

17. The server system as claimed in claim 10, wherein the each future preset interval corresponds to a monthly billing cycle period.

18. A computer-implemented method, comprising:
providing, by a payment server associated with a payment network, a recurring rewards deposit (RRD) offer to a user, the RRD offer requesting the user to provide a commitment to achieve a target number of reward points in each future monthly billing cycle period for a predefined time duration in return of an award;
subsequent to a selection of the RRD offer by the user, determining by the payment server, an average number of reward points earned in a monthly billing cycle period by the user, the average number of reward points determined based on payment card transactions previously executed by the user;
based at least in part on the average number of reward points, generating at least one option by the payment server, each option from among the at least one option associated with a respective reward point target and a predetermined number of bonus reward points for achieving the respective reward point target, the respective reward point target to be achieved by the user in the each future monthly billing cycle period for the predefined time duration;
providing the at least one option, by the payment server, to the user for user selection;
subsequent to the user selection of an option from among the at least one option, tracking by the payment server, reward points earned in the each future monthly billing cycle period for the predefined time duration; and
in response to achieving the reward point target associated with the selected option in the each future monthly billing cycle period for the predefined time duration, facilitating, by the payment server, crediting of the predetermined number of bonus reward points associated with the selected option to a payment account associated with the user.

19. The method as claimed in claim 18, further comprising:
using, by the payment server, one or more machine learning based algorithms to:
identify a pattern of payment card related spending by the user; and
predict the respective reward point target capable of being earned by the user based on the identified pattern of payment card related spending.

20. The method as claimed in claim 18, further comprising:
causing, by the payment server, display of at least one of a total number of reward points and the predetermined number of bonus reward points earned by the user subsequent to a completion of the predefined time duration; and
facilitating, by the payment server, redemption of at least a portion of the total number of reward points subsequent to the crediting of the predetermined number of bonus reward points in the payment account associated with the user.
